(19) United States
(12) Patent Application Publication
(10) Pub. No.: US 2017/0158916 A1
(43) Pub. Date: Jun. 8, 2017

(54) ADHESIVE TAPE, ELECTRONIC DEVICE, AND METHOD FOR DISMANTLING ARTICLE

(71) Applicant: DIC CORPORATION, Tokyo (JP)

(72) Inventors: Seiji Akiyama, Saitama (JP); Akinori Morino, Saitama (JP)

(73) Assignee: DIC CORPORATION, Tokyo (JP)

(21) Appl. No.: 15/320,487

(22) PCT Filed: Jun. 25, 2015
(86) PCT No.: PCT/JP2015/068311

§ 371 Date: Dec. 20, 2016

(30) Foreign Application Priority Data
Jul. 4, 2014 (JP) 2014-138651
Oct. 20, 2014 (JP) 2014-213665
Apr. 3, 2015 (JP) 2015-076813

(51) Int. Cl. C09J 7/02; C09J 5/06; C09J 153/02

(52) U.S. Cl. CPC C09J 7/02; C09J 153/02; C09J 5/06; C09J 2203/326; C09J 2205/302; C09J 2453/00

(57) ABSTRACT

An object of the present invention is to provide an adhesive tape that has very good adhesion in a temperature range of not greater than 60° C. and that rapidly decreases its adhesion after heating for a short period of time. The invention relates to an adhesive tape including a rubber-based adhesive layer. The storage modulus G₁₂₀ of the adhesive component present in the adhesive layer at 120° C. is 1.0×10³ to 2.0×10⁵ Pa. The ratio (G₂₃/G₁₂₀) of the storage modulus G₂₃ of the adhesive component at 23° C. to the storage modulus G₁₂₀ is 1 to 20.

### TECHNICAL FIELD

The present invention relates to adhesive sheets that can be used in a variety of fields, including the manufacture of electronic devices.

### BACKGROUND ART

Studies have been made on the use of adhesive tapes in the manufacture of various electronic devices, including, copiers and multifunction devices with functions such as copying and scanning.

For example, there is a known double-sided adhesive tape having an adhesive layer formed on both sides of a nonwoven fabric substrate (see, for example, PTL 1). This double-sided adhesive tape has an interfacial failure area fraction of 10% or less and a tensile strength of 20 N/10 mm or more in both the machine direction (MD) and the transverse direction (TD).

Used and discarded electronic devices are often manually dismantled before their components are sorted according to material and are discarded or recycled. Specifically, copiers and multifunction devices are often manually dismantled into transparent top plates and housings before they are sorted according to material and are discarded or recycled.

However, such electronic devices may be difficult to manually dismantle since the transparent top plates are firmly bonded to the housings by taking into account the load due to repeated placement of paper media such as documents, pictures, and books on the surface thereof.

Accordingly, studies have been made on removing part of the transparent top plates by cutting using a cutting machine or other equipment at electronic-device dismantling sites, rather than manually removing the transparent top plates from the housings.

However, cutting may be undesirable since it often requires an extended period of time and thus decreases the dismantling efficiency. In addition, part of the transparent top plates remains bonded to part of the housings and therefore cannot be separated and discarded, which may result in considerable disposal costs.

Thus, there is a need for the development of an adhesive tape that can firmly bond two or more adherends together in a temperature range of not greater than about 60° C., particularly in a room temperature range of about 20° C. to 60° C., and that rapidly decreases its adhesion after heating for a short period of time to allow the two or more adherends bonded together to be separated from each other.

For example, there is a known adhesive tape that can firmly bonding two or more adherends together and that has the property of decreasing its adhesion after treatment such as heating to allow the adherends to be separated from each other (see, for example, PTL 2). This adhesive tape is heated and humidified using a heated-steam generator to allow dismantling.

This dismantling method may allow two or more components (adherends) held together with the adhesive tape to be easily separated from each other. This dismantling method, however, may cause component failure and damage if components that are susceptible to heat or other factors are used, in the surrounding area, which is also affected by heat and moisture. In particular, this method may cause problems such as component failure and deformation under the effect of heat or other factors during dismantlement and may thus make it impossible to recycle the components if the adherends are components that are relatively susceptible to heat and are expensive, such as electronic components and resin housings that form electronic devices.

### CITATION LIST

### Patent Literature

PTL 1: Japanese Unexamined Patent Application Publication No. 2001-152111

PTL 2: Japanese Unexamined Patent Application Publication No. 2014-008450

### SUMMARY OF INVENTION

### Technical Problem

An object of the present invention is to provide an adhesive tape that has very good adhesion in a temperature range of not greater than 60° C. and that rapidly decreases its adhesion after heating for a short period of time.

A second object of the present invention is to provide an article dismantling method that allows an adhesive tape or an area where the adhesive tape is attached to be locally heated with a reduced effect of heat on components such as those present in the surrounding area when two or more adherends are separated from each other.

### Solution to Problem

The present invention relates to an adhesive tape including an adhesive layer (A) containing a rubber block copolymer (a). The storage modulus G₁₂₀ of the adhesive component present in the adhesive layer (A) as determined from a dynamic viscoelasticity spectrum at 1 Hz and 120° C. is 1.0×10³ to 2.0×10⁵ Pa. The ratio (G₂₃/G₁₂₀) of the storage modulus G₂₃ of the adhesive component as determined from a dynamic viscoelasticity spectrum at 1 Hz and 23° C. to the storage modulus G₁₂₀ is 1 to 20. The adhesive tape is used to bond two of more adherends together and is heated using a halogen lamp when the two or more adherends bonded together are separated from each other.

The present invention is also intended to achieve the foregoing object by providing a method for dismantling an article including at least two adherends (c1) and (c2) bonded together with an adhesive tape. This dismantling method includes the steps of [1] placing or temporarily fixing a member (b) having an infrared emissivity of 50% or less on a portion of a surface of the article; and [2] exposing a side of the article where the member (b) is placed or temporarily fixed to infrared radiation to allow the adherends (a1) and (a2) to be separated from each other.

### Advantageous Effects of Invention

The adhesive tape according to the present invention has sufficient adhesion to hold two or more adherends together in a temperature range of not greater than 60° C., particularly about 20° C. to 60° C., even if a narrow adhesive tape has to be used because the area available for the attachment of the adhesive tape (attachment area) is limited.

The adhesive tape according to the present invention also has the property of rapidly decreasing its adhesion after healing to about 120° C. to allow the two or more adherends bonded together to be easily separated from each other.

The dismantling method according to the present invention allows the adhesive tape or the area where it is attached to be locally heated while preventing problems due to heat such as failure and deformation of components present in the area where the adhesive tape is not attached. The dismantling method according to the present invention is therefore suitable for applications such as the dismantling of electronic devices, such as portable electronic terminals, including components that are relatively susceptible to heat and are expensive.

### BRIEF DESCRIPTION OF DRAWINGS

FIG. 1 shows schematic views illustrating a test method for surface adhesion strength.

FIG. 2 shows schematic views illustrating the shape of an example member.

FIG. 3 is a side view illustrating a test method for dismantlability.

FIG. 4 is a schematic view illustrating a method for exposure to infrared radiation in a dismantlability test.

### DESCRIPTION OF EMBODIMENTS

An adhesive tape according to the present invention includes an adhesive layer (A) containing a rubber block copolymer (a). The storage modulus G₁₂₀ of the adhesive component present in the adhesive layer (A) as determined from a dynamic viscoelasticity spectrum at 1 Hz and 120° C. is 1.0×10³ to 2.0×10⁵ Pa. The ratio (G₂₃/G₁₂₀) of the storage modulus G₂₃ of the adhesive component as determined from a dynamic viscoelasticity spectrum at 1 Hz and 23° C. to the storage modulus G₁₂₀ is 1 to 20. The adhesive tape is used to bond two or more adherends together and is heated using a halogen lamp when the two or more adherends bonded together are separated from each other.

The adhesive tape according to the present invention may be an adhesive tape composed of one or more adhesive layers (A), i.e., an unsupported adhesive tape, or may be an adhesive tape including an adhesive layer (A) disposed on one or both sides of a substrate, either directly or with another layer therebetween. Preferably, the adhesive tape is an adhesive tape including an adhesive layer (A) disposed on both sides of a substrate, either directly or with another layer therebetween.

The adhesive layer (A) that forms the adhesive tape according to the present invention contains, for example, adhesive components such as the rubber block copolymer (a), which can impart pressure-sensitive adhesion, and an optional tackifier resin as well as other optional additives.

The storage modulus G₁₂₀ of the adhesive components present in the adhesive layer (A) as a frequency of 1 Hz and 120° C. is 1.0'10³ to 2.0×10⁵ Pa. An adhesive tape including an adhesive layer (A) containing adhesive components having a storage modulus G₁₂₀ within the above range exhibits very good adhesion in a temperature range of not greater than 60° C. and significantly decreases its adhesion after heating for a short period of time using a relatively simple heater such as a halogen lamp to allow two or more adherends bonded together to be easily separated from each other.

The adhesive components preferably have a storage modulus G₁₂₀ of 1.0×10³ to 1.8×10⁵ Pa. A storage modulus G₁₂₀ of 5.0×10³ to 1.6×10⁵ Pa is more preferred to provide an adhesive tape that exhibits a better adhesion in a temperature range of not greater than 60° C. and that significantly decreases its adhesion after heating for a short period of time using a relatively simple heater such as a halogen lamp to allow two or more adherends bonded together to be separated from each other.

The storage modulus G′ of the adhesive components present in the adhesive layer (A) at a frequency of 1 Hz and 23° C. is preferably 1.0×10⁴ Pa or more, more preferably 5.0×10⁴ to 2.0×10⁶ Pa. A storage modulus G′ of 8.0×10⁵ to 1.5×10⁶ Pa is even more preferred since such adhesive components can impart sufficient adhesion to hold components together even if a narrow adhesive tape has to be used because the area available for the attachment of the adhesive tape (attachment area) is limited.

The ratio (G₂₃/G₁₂₀) of the storage modulus G₂₃ of the adhesive components present in the adhesive layer (A) as determined from a dynamic viscoelasticity spectrum at 1 Hz and 23° C. to the storage modulus G₁₂₀ is 1 to 20. An adhesive tape including an adhesive layer (A) containing adhesive components having a ratio (G₂₃/G₁₂₀) within the above range is preferred since it exhibits very good adhesion in a temperature range of not greater than 60° C. and significantly decreases its adhesion after heating for a short period of time using a relatively simple heater such as a halogen lamp to allow two or more adherends bonded together to be separated from each other.

The ratio (G₂₃/G₁₂₀) is preferably 1 to 20, more preferably 1 to 18. A ratio (G₂₃/G₁₂₀) of 1 to 15 is even more preferred since such an adhesive tape exhibits very good adhesion in a temperature range of not greater than 60° C. and significantly decreases its adhesion after heating for a short period of time using a relatively simple heater such as a halogen lamp to allow two or more adherends bonded together to be separated from each other.

An adhesive layer (A) that softens or melts after heating using a halogen lamp is preferred to significantly decrease the adhesion after heating for a short period of time using a relatively simple heater such as a halogen lamp to allow two or more adherends bonded together to be separated from each other. Preferably, the adhesive layer (A) can soften or melt rapidly after heating above the glass transition temperature of the rubber block copolymer (a) present in the adhesive layer (A).

The adhesive layer (A) significantly decreases its adhesion to allow two or more adherends bonded together to be separated from each other at a lower temperature than those intended for heating using heaters other than halogen lamps. This reduces the likelihood of problems such as adherend deformation, discoloration, and failure under the effect of heat when two or more adherends are separated from each other. Specifically, the adhesive layer (A) is preferably heated to 80° C. to 130° C., more preferably 80° C. to 125° C., even more preferably 90° C. to 120° C., when two or more adherends are separated from each other. The adhesive layer (A) is preferably heated for 3 to 20 seconds, more preferably 3 to 15 seconds, which is relatively short.

Generally, a halogen lamp can quickly reach the preferred temperature range (e.g., 80° C. to 130° C.) upon power-up, thereby quickly heating an object by radiant heat. The adhesive layer (A), which readily softens or melts rapidly in the preferred temperature range, significantly decreases its adhesion after heating using a halogen lamp for a short period of time to allow two or more adherends bonded together to be easily separated from each other.

As mentioned above, the adhesive layer (A) contains adhesive components such as the rubber block copolymer (a) and an optional tackifier resin as well as other optional additives.

The rubber block copolymer (a) may be an ABA block copolymer (triblock copolymer), an AB block copolymer (diblock copolymer), or a mixture thereof.

A mixture of triblock and diblock copolymers is preferred as the rubber block copolymer (a) to provide an adhesive tape that has the storage modulus at 23° C. as described above, the storage modulus at 120° C. as described above, and the storage modulus at 23° C. divided by the storage modulus determined at 120° C. as described above and that exhibits very high adhesion in a room-temperature range of around 23° C. and decreases its adhesion after heating to about 120° C. to allow two or more adherends to be easily separated from each other. The diblock copolymer is preferably present in an amount of 10% to 90% by mass, more preferably 15% to 80% by mass, even more preferably 20% to 75% by mass, of the total mass of the rubber block copolymer (a).

The peel distance of the adhesive tape according to the present invention as determined by a constant-load bearing capacity test at 23° C. is preferably 20 mm or less. A peel distance of 10 mm or less is more preferred since such an adhesive tape is resistant to problems such as peeling when a certain external stress is applied to the adhesive tape.

A preferred rubber block copolymer (a) is a styrene block copolymer. The styrene block copolymer is a triblock copolymer, a diblock copolymer, or a mixture thereof containing a polystyrene unit (a1) and a polyolefin unit.

The polystyrene unit (a1) increases the modulus of the adhesive layer (A) and thus provides very good adhesion in a temperature range of not greater than 60° C. and also contributes to the property of significantly decreasing its adhesion after heating using a halogen lamp for a short period of time.

Examples of styrene block copolymers that can be used include polystyrene-poly(isoprene) block copolymers, polystyrene-poly(isoprene)-polystyrene block copolymers, polystyrene-poly(butadiene) block copolymers, polystyrene-poly(butadiene)-polystyrene block copolymers, polystyrene-poly(butadiene/butylene) block copolymers, polystyrene-poly(butadiene/butylene)-polystyrene block copolymers, polystyrene-poly(ethylene/propylene) block copolymers, polystyrene-poly(ethylene/propylene)-polystyrene block copolymers, polystyrene-poly(ethylene/butylene) block copolymers, polystyrene-poly(ethylene/butylene)-polystyrene block copolymers, polystyrene-poly(ethylene-ethylene/propylene) block copolymers, and polystyrene-poly(ethylene-ethylene/propylene)-polystyrene block copolymers. Preferred among these styrene block copolymers are block copolymers containing a polystyrene unit (a1) and a polyisoprene unit (a2). Polystyrene-poly(isoprene) block copolymers, polystyrene-poly(butadiene) block copolymers, and polystrene-poly(butadiene)-polystyrene block copolymers are more preferred to provide a thermally dismantlable adhesive tape that exhibits very good adhesion in a temperature range of not greater than 60° C. and significantly decreases its adhesion after heating for a short period of time using a relatively simple heater such as a halogen lamp to allow two or more adherends bonded together to be separated from each other.

The rubber block copolymer (a) preferably has a weight average molecular weight of 10,000 to 800,000, more preferably 50,000 to 500,000, even more preferably 150,000 to 450,000, so that the adhesive tape has a better adhesion and a higher thermal dismantlability.

In addition to the rubber block copolymer (a), the adhesive layer (A) preferably contains optional adhesive components such as tackifier resins.

Examples of tackifier resins that can be used include rosin tackifier resins, polymerized rosin tackifier resins, polymerized rosin ester tackifier resins, rosin-phenol tackifier resins, hydrogenated rosin ester tackifier resins, disproportionated rosin ester tackifier resins, terpene tackifier resins, terpene-phenol tackifier resins, aliphatic (petroleum resin) tackifier resins, and C5 petroleum tackifier resins.

Among these tackifier resins, C5 petroleum tackifier resins and terpene-phenol tackifier resins are preferred to improve the wettability on adherend surfaces. In particular, terpene-phenol tackifier resins are preferred to impart moderate flexibility and very good adhesion in a temperature range of about 20° C. to 60° C. to the adhesive layer (A) and to provide a thermally dismantlable adhesive tape that is resistant to problems such as peeling over time when a certain repulsive force is applied to the tape.

Examples of C5 tackifier resins that can be used include resins obtained by extracting and removing isoprene and cyclopentadiene from C5 fractions, which are generally obtained by naphtha cracking, and polymerizing the remainder.

Examples of terpene-phenol tackifier resins that can be used include resins obtained by copolymerization of terpene monomers with phenol. Terpene-phenol tackifier resins with softening points of 105° C. to 145° C. are preferred to improve the compatibility with the rubber block copolymer (a) and thereby impart very good adhesion in a temperature range of not greater than 60° C. and to provide a peel-resistant adhesive tape that is resistant to problems such as peeling over time when a certain repulsive force is applied to the tape.

Such tackifier resins are preferably used in an amount of 10 to 150 parts by mass, more preferably 15 to 100 parts by mass, per 100 parts by mass of the rubber block copolymer (a).

In particular, terpene-phenol tackifier resins are preferably used in an amount of 50 to 100 parts by mass per 100 parts by mass of the rubber block copolymer (a). More preferably, terpene-phenol tackifier resins are used in an amount of 65 to 80 parts by mass to impart very good adhesion in a temperature range of not greater than 60° C. and to provide a peel-resistant thermally dismantlable adhesive tape that is resistant to problems such as peeling over time when a certain repulsive force is applied to the tape. C5 tackifier resins are preferably used in an amount of 10 to 100 parts by mass, more preferably 20 to 50 parts by mass, even more preferably 25 to 50 parts by mass, per 100 parts by mass of the rubber block copolymer (a).

In addition to the tackifier resins described above, tackifier resins that are liquid at room temperature can also be used. Examples of such liquid tackifier resins include process oils, polyester tackifier resins, and low-molecular-weight liquid rubbers such as polybutene.

In addition to the adhesive components, the adhesive layer (A) may contain other optional ingredients, such as infrared absorbers; antioxidants; ultraviolet absorbers; fillers; glass and plastic fibers; fillers such as thermally expandable balloons, beads, and metal powders; pigments; and thickeners.

In particular, infrared absorbers are preferred since they can improve the speed at which the adhesive tape according to the present invention is heated so that the adhesive tape decreases its adhesion within a shorter heating time during heating using a halogen lamp to allow two or more adherends bonded together to be separated from each other.

Examples of suitable infrared absorbers that can be used include known infrared absorbers, including inorganic pigments such as carbon black and complex oxide pigments; organic pigments such as phthalocyanine pigments, lake pigments, and polycyclic pigments; and various dyes.

Such infrared absorbers are preferably present in an amount of 0.01% to 20% by mass of the total mass of the adhesive layer (A).

Thermally expandable balloons are also preferred since they allow two or more adherends bonded together to be separated from each other with a weaker force when the adhesive tape according to the present invention is heated to allow the two or more adherends to be separated from each other.

Examples of thermally expandable balloons that can be used include commercially available thermally expandable balloons such as Matsumoto Microsphere (trade name, Matsumoto Yushi Seiyaku Co., Ltd.), Microsphere Expancel (trade name, Japan Fillite Co., Ltd.), and Dyfoam (trade name, Dainichiseika Color & Chemicals Mfg. Co., Ltd.).

Such thermally expandable balloons are preferably present in an amount of 3% to 50% by mass, more preferably 5% to 30% by mass, even more preferably 10% to 20% by mass, of the mass of the adhesive components present in the adhesive layer (A) to provide an adhesive tape that maintains good adhesion in a temperature range of not greater than 60° C. and that allows two or more adherends bonded together to be separated from each other with a weaker force after heating.

For example, the adhesive layer (A) disposed on one side of the substrate of the adhesive tape preferably has a thickness of 25 μm or more, more preferably 60 to 120 μm. An adhesive laser (A) having a thickness of 80 to 120 μm is even more preferred to provide an adhesive tape that has good cohesion, that exhibits very good adhesion in a temperature range of not greater than 60°C., and that significantly decreases its adhesion after heating for a short period of time using a relatively simple heater such as a halogen lamp to allow two or more adherends bonded together to be separated from each other.

For example, the adhesive layers (A) disposed on both sides of the substrate of the adhesive tape preferably have a total thickness of 50 μm or more, more preferably 50 to 300 μm, even more preferably 100 to 250 μm. Adhesive layers (A) having a total thickness of 100 to 210 μm are still more preferred to provide an adhesive tape that has good cohesion, that exhibits very good adhesion in a temperature range of not greater than 60° C., and that allows two or more adherends bonded together to be separated from each other with a weaker force after heating.

As described above, the adhesive tape according to the present invention may be an adhesive tape including an adhesive layer (A) disposed on one or both sides of a substrate, either directly or with another layer therebetween.

Examples of substrates that can be used include nonwoven fabric substrates and resin film substrates. Preferred among these substrates are substrates with good infrared absorption properties (infrared-absorbing substrates).

Examples of infrared-absorbing substrates include resin film substrates containing an infrared-absorbing inorganic filler, organic colorant, inorganic colorant, dye, or pigment and resin film substrates having an infrared-absorbing layer.

Among these infrared-absorbing substrates, black substrates are preferred since they impart suitable heat absorption and storage properties to the adhesive tape so that it can be heated using a relatively simple heater such as a halogen lamp over a wide area within a short period of time to allow two or more adherends to be separated from each other. This reduces the exposure time and thus significantly improves the efficiency of separating two or more adherends from each other.

However, for example, if an adhesive tape including a black substrate is exposed using a local heater such as a semiconductor laser without strict power control, only the substrate may be heated, and the two or more adherends may be insufficiently separated from each other. In addition, only the substrate may be heated to a high temperature, which may result in problems such as deformation. It is therefore preferred to use an adhesive tape including a black substrate in combination with heating using a halogen lamp.

Any black substrate may be used. Examples of black substrates include resin substrates having a black ink layer printed thereon, resin film substrates containing a black pigment, and nonwoven fabric substrates having a black pigment dispersed therein.

The substrate preferably has a thickness of 4 to 100 μm. A substrate having a thickness of 10 to 73 μm is more preferred to impart good workability and good conformity to adherends to the adhesive tape.

Examples of resin film substrates that can be used include polyethylene terephthalate substrates. Resin film substrates subjected to corona treatment or anchor coating can also be used to improve the anchoring effect of the adhesive layer (A).

The adhesive tape according to the present invention can be manufactured, for example, by applying an adhesive containing the rubber block copolymer (a) and other ingredients to one or both sides of the substrate using a device such as a roll coater or die coater and then drying the adhesive to form the adhesive layer (A).

The adhesive tape can also be manufactured by transfer. This process includes applying an adhesive containing the rubber block copolymer (a) and other ingredients to a surface of a release liner using a device such as a roll coater, drying the adhesive to form the adhesive layer (A), and attaching the adhesive layer (A) to one or both sides of the substrate.

The adhesive tape according to the present invention exhibits very good adhesion, for example, in a temperature range of not greater than 60° C. The adhesive tape is therefore suitable for bonding various adherends.

The adhesive tape preferably has a 180° peel adhesion of about 15 to 40 N/20 mm on a stainless steel plate, for example, in a room-temperature (23° C.) environment. An adhesion of about 20 to 40 N/20 mm is more preferred to firmly bond adherends together and thereby prevent problems such as peeling over time.

An example method for manufacturing an article by bonding two or more adherends together using the adhesive tape includes attaching one adhesive layer (A) that forms the adhesive tape to a surface of one adherend and attaching another adherend to a surface of the other adhesive layer (A), optionally followed by processes such as pressing.

An example method for dismantling the article includes directly or indirectly heating the adhesive tape by placing a halogen lamp close to or in contact with the adhesive tape or the adherends that form the article to allow the two or more adherends bonded together to be separated from each other.

During the heating, the halogen lamp may be placed close to or in contact with the adhesive tape, or may be placed close to or in contact with the adherends to indirectly heat the adhesive tape. For example, if an end of the adhesive tape is located outside an end of the adherends, the halogen lamp may be placed close to or in contact with the end of the adhesive tape.

In the heating step, the adhesive tape is preferably heated to 80° C. to 130° C., more preferably 85° C. to 125° C., even more preferably 90° C. to 120° C., using a heater including a halogen lamp. The adhesive tape is preferably heated within 20 seconds, more preferably within 15 seconds, even more preferably within 10 seconds, which is relatively short.

Specifically, the step of heating using the halogen lamp preferably involves heating the adhesive tape to 100° C. within 20 seconds, which improves the efficiency of dismantling the article while preventing problems such as adherend deformation due to heat.

Examples of halogen lamp heaters that can be used include collimated-light halogen lamp heaters, which can heat a certain area within a short period of time, and concentrated-light halogen lamp heaters, which can perform local heating. Collimated-light halogen lamp heaters are preferred since they can simultaneously heat a wide area and thus require only a short heating time as described above.

A collimated-light halogen lamp heater having a maximum simultaneous heating area of about 10 to 500 cm² is preferred. A heater, such as a collimated-light halogen lamp heater, of portable size and weight is also preferred to improve the efficiency of dismantling the article. The weight is preferably 3 kg or less, more preferably 2 kg or less, even more preferably 0.1 to 1 kg.

The article heated by this method can be easily dismantled with little force, or only a weak force, exerted on the two or more adherends that form the article. The adherends have little adhesive residue derived from the adhesive tape and can thus be used, for example, for recycling.

The adhesive tape according to the present invention has very good adhesion in a temperature range of not greater than 60° C. and can thus be used, for example, to bond together a transparent top plate and a housing that form an electronic device such as a copier or multifunction device with functions such as copying and scanning.

The transparent top plate may be a transparent top plate for mounting on common copiers and multifunction devices with functions such as copying and scanning.

Examples of transparent top plates that can be used include glass and plastic rigid transparent plates. Examples of plastic plates that can be used include acrylic plates and polycarbonate plates.

The transparent top plate may be of any shape matching that of a device, such as a copier, on which the transparent top plate is to be mounted. Square and rectangular transparent top plates are generally preferred.

For example, if a rectangular transparent top plate is used, the adhesive tape is preferably attached along two opposing sides of the transparent top plate. In this case, the adhesive tape may be cut to a size corresponding to the length of the sides of the transparent top plate. For example, the adhesive tape preferably has a width of 0.5 to 20 mm and a length of 0.1 to 2.0 mm.

The adhesive tape according to the present invention can be used mainly for the bonding of the members that form a portable electronic device. Such members may be, for example, two or more members such as housings and lens members that form an electronic device.

An example portable electronic device including such members is a portable electronic device including a housing and a lens member or another housing that are bonded together with the adhesive tape.

These members may be bonded together, for example, by placing the housing and the lens member on top of each other with the adhesive tape therebetween and allowing the adhesive tape to stand for a predetermined period of time.

A dismantling method according to a second invention will now be described.

The dismantling method according to the present invention is a method for dismantling an article including at least two adherends (c1) and (c2) bonded together with an adhesive tape. This dismantling method includes the steps of [1] placing or temporarily fixing a member (b) having an infrared emissivity of 50% or less on a portion of a surface of the article; and [2] exposing a side of the article where the member (b) is placed or temporarily fixed to infrared radiation to allow the adherends (c1) and (c2) to be separated from each other.

The dismantling method according to the present invention is characterized by efficiently heating the portion of the article that requires heating while eliminating the effect of infrared radiation on the portion of the article that requires no heating, rather than simply heating the article by exposure to infrared radiation.

Specifically, the dismantling method according to the present invention includes placing or temporarily fixing the member (b) having an infrared emissivity of 50% or less on the surface of the portion of the article where the effect of infrared radiation should be eliminated. The member (b) is not provided on the surface of the portion to be exposed to infrared radiation.

The side of the article where the member (b) is provided is then exposed to infrared radiation. During this step, the area masked by the member (b) is not affected by infrared radiation and is therefore not practically heated, which reduces the likelihood of problems such as component damage under the effect of heat.

The area not masked by the member (b) is heated under the effect of infrared radiation. If the area not masked by the member (b) matches the area of the article where the adhesive tape is provided, the adhesive tape is heated by infrared radiation and thus significantly decreases its adhesion to allow the two or more adherends bonded together with the adhesive tape to be separated from each other.

Step [1] will be described first.

Step [1] involves masking a portion of the surface of the article with the member (b).

The member (b) is preferably provided only on the surface of the area of the article where the effect of heat needs to be minimized, rather than over the entire surface of the article.

The member (b) may be provided on a portion of at least one of the adherends (c1) and (c2) that form the article or at a position other than the adherends (c1) and (c2).

The member (b) may be provided in any manner on the surface of the article. For example, the member (b) may be provided in a shape corresponding to that of the article or may be cut (patterned) in advance to remove only the area to be exposed to infrared radiation. Specifically, if the area where a frame-shaped adhesive tape is attached is exposed to infrared radiation, a sheet cut to reveal only the frame-shaped area may be used as the member (b) so that only the frame-shaped area can be exposed to infrared radiation. The member (b) may be repeatedly used.

The member (b) may be simply placed on a portion of the article or may be temporarily fixed, for example, with an adhesive tape.

Step [2] will then be described.

Step [2] involves exposing the side of the article where the member (b) is placed or temporarily fixed to infrared radiation to allow the adherends (c1) and (c2) to be separated from each other.

Specifically, step [2] involves exposure to, for example, infrared radiation or a radiation or laser beam containing infrared radiation.

Infrared radiation reaches the thermally dismantlable adhesive sheet that forms the article directly or through the adherend (c1), the adherend (c2), or another transparent member that forms the article to heat the thermally dismantlable adhesive sheet to a suitable temperature.

Although the exposure may be performed using known light sources such as halogen lamps, commercially available portable halogen heaters are preferred. These heaters allow the adhesive layer that forms the adhesive tape to be heated and softened within a short period of time and thus significantly improve the dismantling efficiency.

During the exposure, the adhesive tape is preferably separated from a light source (lamp) such as a halogen lamp heater by a distance of, for example, about 5 to 100 mm, more preferably 5 to 50 mm. A distance of 5 to 30 mm is even more preferred to soften the adhesive layer that forms the adhesive tape within a short period of time and thereby improve the dismantling efficiency. In particular, a shorter distance results in a shorter exposure time since a halogen lamp emits infrared radiation radially.

The time for exposure to infrared radiation is preferably about 2 to 20 seconds, more preferably about 3 to 15 seconds. An exposure time of about 5 to 15 seconds is even more preferred to improve the dismantling efficiency.

During the exposure to infrared radiation, the thermally dismantlable adhesive sheet that forms the article is preferably heated to 70° C. to 150° C., more preferably 80° C. to 130° C. Heating the adhesive tape to 85° C. to 125° C. is even more preferred to prevent problems such as failure and deformation of adherends (c1) and (c2) that are relatively susceptible to heat so that they can be recycled.

The adherends (c1) and (c2) are preferably separated from each other after the exposure and before the temperature of the adhesive tape drops. Specifically, the adherends (c1) and (c2) are preferably separated from each other within 10 seconds after the exposure.

The member (b) used in the dismantling method according to the present invention has an infrared emissivity of 50% or less, preferably 40% or less, more preferably 30% or less. This allows the thermally dismantlable adhesive sheet or the area where it is attached to be locally heated while preventing problems due to heat such as failure and deformation of components such as those present in the area where the thermally dismantlable adhesive sheet is not attached.

As used herein, the term “infrared emissivity” refers to a measurement obtained using an emissivity meter (TSS-5X, Japan Sensor Corporation, measurement principle: reflected energy detection and calculation with infrared radiation from constant-temperature radiation source) at a specimen/ambient temperature of 23° C., a measurement wavelength of 2 to 22 μm, a measurement area diameter of 15 mm, and a measurement distance of 12 mm (fixed with detection head legs).

Specifically, the member (b) may be, for example, a metal member such as an aluminum, silver, gold, nickel, copper, or stainless steel member; a metal member combined with another member such as a resin member; or any member having a coating with low infrared emissivity formed thereon. Particularly preferred as the member (b) are non-transparent members with low infrared emissivity, including aluminum, stainless steel, and copper plates, which are relatively inexpensive.

A preferred metal member combined with another member such as a resin member is a metal member combined with a resin member containing air, which serves as a thermal insulation layer. Specifically, for example, a metal member combined with a foam is preferred as the member (b) because of its good thermal insulation performance. Examples of foams include polyolefin foams.

The member (b) may have any suitable shape and thickness depending on, for example, the shape of the article to be dismantled and the environment where the dismantling method is implemented.

The member (b) is preferably sufficiently thick not to conduct heat to the article and sufficiently thin not to require excess dismantling space. Specifically, the member (b) preferably has a thickness of about 0.5 to 10 mm.

An example adhesive tape that can be used in the present invention is a thermally dismantlable adhesive tape having both the property of firmly bonding two or more adherends together and the property of significantly decreasing its adhesion under the effect of heat or other factors. Specifically, an adhesive tape including an adhesive layer containing a rubber block copolymer is preferred.

The adhesive tape may be any adhesive tape having the above properties. For example, the adhesive tape may be an adhesive tape including the adhesive layer (A) containing the rubber block copolymer (a) as described above. The storage modules G₁₂₀ of the adhesive component present in the adhesive layer (A) as determined from a dynamic viscoelasticity spectrum at 1 Hz and 120° C. is preferably 1.0×10³ to 2.0×10⁵ Pa. The ratio (G₂₃/G₁₂₀) of the storage modulus G₂₃ of the adhesive component as determined from a dynamic viscoelasticity spectrum at 1 Hz and 23° C. to the storage modulus G₁₂₀ is preferably 1 to 20. Such properties are preferred to provide an adhesive tape that has very good adhesion in a temperature range of not greater than 60° C. and that rapidly decreases its adhesion after heating for a short period of time.

An example article that can be dismantled by the dismantling method according to the present invention is an article including at least two adherends (c1) and (c2) bonded together with the adhesive tape.

Specific examples of such articles include electronic devices, including portable electronic terminals such as smartphones and telephones, personal computers, and information readers such as copiers and multifunction devices.

Rigid plates are suitable as the adherends (c1) and (c2) that form the article and that can be separated from each other by the dismantling method according to the present invention. For example, the adherends (c1) and (c2) may be a transparent top plate and a housing that form a copier or multifunction device. After the adherends (c1) and (c2) are separated from each other by the dismantling method, one or both of them may be discarded or reused as a recycled member.

Examples of transparent top plates that can be used include glass and plastic rigid transparent plates. Examples of plastic plates that can be used include acrylic plates and polycarbonate plates.

The transparent top plate may be of any shape matching that of a device, such as a copier, on which the transparent top plate is to be mounted. Square and rectangular transparent top plates are generally preferred.

For example, if a rectangular transparent top plate is used, the adhesive tape is preferably attached along two opposing sides of the transparent top plate. In this case, the adhesive tape may be cut to a size corresponding to the length of the sides of the transparent top plate. For example, the adhesive tape preferably has a width of 0.5 to 20 mm and a length of 0.1 to 2.0 m.

If the article to be dismantled is a portable electronic terminal, the adherends (c1) and (c2) may be two or more members such as housings and lens members.

An example portable electronic device including such members is a portable electronic device including a housing and a lens member or another housing that are bonded together with the adhesive tape.

These members may be bonded together, for example, by placing the housing and the lens member on top of each other with the adhesive tape therebetween and allowing the adhesive tape to stand for a predetermined period of time.

The present invention is further illustrated by the following examples.

### Preparation Example 1

Adhesive (a-1) was prepared by dissolving in toluene a mixture of 100 parts by mass of Styrene-Butadiene Block Copolymer S with a weight average molecular weight of 300,000 (A mixture of triblock and diblock copolymers. The percentage of the diblock copolymer in the total mass of the mixture was 20% by mass. The mass percentage of polystyrene units in the total mass of the styrene-butadiene block copolymer was 20% by mass. The mass percentage of polybutadiene units in the total mass of the styrene-butadiene block copolymer was 80% by mass) and 40 parts by mass of a C5 petroleum tackifier resin (softening point: 100° C., number average molecular weight: 885).

Adhesive (a-1) was applied to the surface of a release liner using an applicator such that the dry thickness was 100 μm and was then dried at 85° C. for 5 minutes to form an adhesive layer. The adhesive layer was placed on both sides of a substrate having a black ink layer with a thickness of 4 μm formed on both sides of a polyethylene terephthalate film with a thickness of 38 μm and was laminated by pressing at 4 kgf/cm² to obtain Adhesive Tape 1.

Adhesive Tape 1 was cut into two strips with a length of 50 mm and a width of 5 mm. The cut adhesive tapes were attached along the long sides of a transparent glass plate with a length of 50 mm, a width of 40 mm, and a thickness of 0.4 mm to obtain an adherend.

The side of the adherend to which the adhesive tapes were attached was attached around the center of a cuboid white polymer alloy resin plate with a length of 100 mm, a width of 100 mm, and a thickness of 2 mm that was made of an acrylonitrile-butadiene-styrene resin and a polycarbonate resin, and was pressed using a press at 80 N/cm² for 10 seconds. After the pressure was released, the adherends were allowed to stand in an environment at 85° C. for 24 hours to obtain Article 1.

### Preparation Example 2

Adhesive Tape 2 and Article 2 were prepared as in Preparation Example 1except that the polyethylene terephthalate film having the black ink layer in Preparation Example 1 was replaced with a substrate having an infrared-absorbing layer. This substrate was prepared by applying a liquid coating containing 600 parts by mass of PHORET GS-1000 (Soken Chemical Asia Co., Ltd., 30% by mass poly(methyl methacrylate) solution), 6.4 parts by mass of CIR-RL infrared-absorbing dye (Japan Carlit Co., Ltd., diimmonium salt compound), 400 parts by mass of methyl ethyl ketone, and 400 parts by mass of toluene to a polyethylene, terephthalate film with a thickness of 38 μm such that the dry thickness was 4 μm and then drying the coating.

### Preparation Example 3

Adhesive Tape 3 and Article 3 were prepared as in Preparation Example 1 except that the polyethylene terephthalate film having the black ink layer in Preparation Example 1 was replaced with a polyethylene terephthalate film (PET film) with a thickness of 38 μm that had no black ink layer.

### Preparation Example 4

Adhesive Tape 4 and Article 4 were prepared as in Preparation Example 3 except that Adhesive (a-1) was replaced with Adhesive (a-2). Adhesive (a-2) was prepared by mixing Adhesive (a-1) with 0.5 part by mass of carbon black (infrared absorber) available from Evonik Degussa Japan Co., Ltd., which is not an adhesive component.

### Preparation Example 50

Adhesive Tape 5 and Article 5 were prepared as in Preparation Example 3 except that Styrene-Butadiene Block Copolymer S was replaced with Styrene-Butadiene Block Copolymer T with a weight average molecular weight of 300,000 (A mixture of triblock and diblock copolymers. The percentage of the diblock copolymer in the total mass of the mixture was 20% by mass. The mass percentage of polystyrene units in the total mass of the styrene-butadiene block copolymer was 15% by mass. The mass percentage of polybutadiene units in the total mass of the styrene-butadiene block copolymer was 85% by mass).

### Preparation Example 6

Adhesive Tape 6 and Article 6 were prepared as in Preparation Example 3 except that Styrene-Butadiene Block Copolymer S was replaced with Styrene-Butadiene Block Copolymer U with a weight average molecular weight of 320,000 (A mixture of triblock and diblock copolymers. The percentage of the diblock copolymer in the total mass of the mixture was 30% by mass. The mass percentage of polystyrene units in the total mass of the styrene-butadiene block copolymer was 20% by mass. The mass percentage of polybutadiene units in the total mass of the styrene-butadiene block copolymer was 80% by mass).

### Preparation Example 7

Adhesive Tape 7 and Article 7 were prepared as in Preparation Example 3 except that Styrene-Butadiene Block Copolymer S was replaced with Styrene-Butadiene Block Copolymer V with a weight average molecular weight of 400,000 (A mixture of triblock and diblock copolymers. The percentage of the diblock copolymer in the total mass of the mixture was 15% by mass. The mass percentage of polystyrene units in the total mass of the styrene-butadiene block copolymer was 10% by mass. The mass percentage of polybutadiene units in the total mass of the styrene-butadiene block copolymer was 90% by mass).

### Preparation Example 8

Adhesive Tape 8 and Article 8 were prepared as in Preparation Example 3 except that the amount of C5 petroleum tackifier resin (softening point: 100° C., number average molecular weight: 885) used was changed from 40 parts by mass to 20 parts by mass.

### Preparation Example 9

Adhesive Tape 9 and Article 9 were prepared as in Preparation Example 1 except that Styrene-Butadiene Block Copolymer S was replaced with 100 parts by mass of Styrene-Butadiene Block Copolymer X with a weight average molecular weight of 300,000 (A mixture of triblock and diblock copolymers. The percentage of the diblock copolymer in the total mass of the mixture was 50% by mass. The mass percentage of polystyrene units in the total mass of the styrene-butadiene block copolymer was 30% by mass. The mass percentage of polybutadiene units in the total mass of the styrene-butadiene block copolymer was 70% by mass), and the C5 petroleum tackifier resin was replaced with 65 parts by mass of a terpene-phenol tackifier resin (softening point: 115° C., molecular weight: 1,000).

### Preparation Example 10

Adhesive Tape 10 and Article 10 were prepared as in Preparation Example 9 except that the polyethylene terephthalate film having the black ink layer in Preparation Example 9 was replaced with a polyethylene terephthalate film with a thickness of 25 μm that contained a black pigment.

### Preparation Example 11

Adhesive Tape 11 and Article 11 were prepared as in Preparation Example 9 except that the amount of terpene-phenol tackifier resin (softening point: 115° C. molecular weight: 1,000) used in Preparation Example 9 was changed from 65 parts by mass to 75 parts by mass.

### Preparation Example 12

Adhesive Tape 12 and Article 12 were prepared as in Preparation Example 9 except that the adhesive used in Preparation Example 9 was replaced with an adhesive prepared by mixing the adhesive used in Preparation Example 9 With Matsumoto Microsphere F-48 (Matsumoto Yushi Seiyaku Co., Ltd., thermal expansion coefficient at 120° C.: 370%, expansion onset temperature: 90° C. to 100° C., maximum expansion temperature: 125° C. to 135° C., average particle size (before expansion): 9 to 15 μm), which is not an adhesive component. Matsumoto Microsphere F-48 was used in an amount of 15 parts by mass of the adhesive components (including Styrene-Butadiene Block Copolymer W and the terpene-phenol tackifier resin).

### Comparative Preparation Example 1

Adhesive Tape 13 and Article 13 were prepared as in Preparation Example 1 except that Styrene-Butadiene Block Copolymer S was replaced with Styrene-Butadiene Block Copolymer W with a weight average molecular weight of 1,000,000 (A mixture of triblock and diblock copolymers. The percentage of the diblock copolymer in the total mass of the mixture was 20% by mass. The mass percentage of polystyrene units in the total mass of the styrene-butadiene block copolymer was 30% by mass. The mass percentage of polybutadiene units in the total mass of the styrene-butadiene block copolymer was 70% by mass).

### Comparative Preparation Example 2

Preparation of Adhesive (a-3)

In a reaction vessel equipped with a stirrer, a reflux condenser, a thermometer, a dropping funnel, and a nitrogen gas inlet, 44.9 parts by mass of butyl acrylate, 50 parts by mass of 2-ethylhexyl acrylate, 2 parts by mass of acrylic acid, 3 parts by mass of vinyl acetate, 0.1 part by mass of 4hydroxybutyl acrylate, and 0.1 part by mass of 2,2′-azobisisobutyronitrile, serving as a polymerization initiator, were dissolved in 100 parts by mass of ethyl acetate. The solution was polymerized at 70° C. for 10 hours to obtain a solution of Acrylic Copolymer X with a weight average molecular weight of 800,000.

To 100 parts by mass of Acrylic Copolymer X was added 30 parts by mass of D-135 polymerized rosin ester tackifier resin (Arakawa Chemical Industries, Ltd.). Ethyl acetate was added to the mixture to obtain an acrylic adhesive with a nonvolatile content of 45% by mass.

To 100 parts by mass of the acrylic adhesive was added 1.1 parts by mass of CORONATE L-45 available from Nippon Polyurethane Industry Co., Ltd. (isocyanate crosslinking agent, solid content: 45% by mass). The mixture was stirred for 15 minutes to obtain Acrylic Adhesive (a-3). Acrylic Adhesive (a-3) was applied to a separator using an applicator such that the dry thickness was 100 μm and was then dried at 85° C. for 5 minutes to form an acrylic adhesive layer.

The acrylic adhesive layer was then placed on both sides of a polyethylene terephthalate film with a thickness of 38 μm that had a black ink layer with a thickness of 4 μm formed thereon and was laminated by pressing at 4 kgf/cm² to obtain Adhesive Tape 14.

Article 14 was prepared as in Preparation Example 1 except that the adhesive tape used in Preparation Example 1 was replaced with the above adhesive tape.

### Comparative Preparation Example 3

Adhesive Tape 15 and Article 15 were prepared as in Comparative Preparation Example 2 except that the polyethylene terephthalate film with a thickness of 38 μm that had a black ink layer with a thickness of 4 μm formed thereon in Comparative Preparation Example 2 was replaced with a polyethylene terephthalate film with a thickness of 38 μm that had no black ink layer with a thickness of 4 μm.

### Comparative Preparation Example 4

Preparation of Adhesive (a-4)

In a reaction vessel equipped with a stirrer, a reflux condenser, a thermometer, a dropping funnel, and a nitrogen gas inlet, 100 parts by mass of the combination of monomers shown in Table 1 and 0.2 part by mass of 2,2′-azobisisobutyronitrile, serving as a polymerization initiator, were dissolved in 100 parts by mass of ethyl acetate. The solution was polymerized at 80° C. for 8 hours to obtain Acrylic Copolymer Y.

To 100 parts by mass of Acrylic Copolymer Y were added 10 parts by mass of A-100 rosin ester resin (Arakawa Chemical industries, Ltd.) and 20 parts by mass of D-135 polymerized rosin ester tackifier resin (Arakawa Chemical Industries, Ltd.). The mixture was diluted with toluene to obtain Adhesive (a-4) with a nonvolatile content of 45% by mass.

To 100 parts by mass of Adhesive (a-4) was added 1.1 parts by mass of CORONATE L-45 available from Nippon Polyurethane Industry Co., Ltd. (isocyanate crosslinking agent, solid content: 45% by mass), followed by stirring for 15 minutes. The adhesive was applied to a separator using an applicator such that the dry thickness was 100 μm and was then dried at 85° C. for 5 minutes to form an adhesive layer.

The adhesive layer was then placed on both sides of a polyethylene terephthalate film with a thickness of 38 μm that had a black ink layer with a thickness of 4 μm formed thereon and was laminated by pressing at 4 kgf/cm² to obtain Adhesive Tape 16.

Article 16 was prepared as in Preparation Example 1 except that Adhesive Tape 1 was replaced with Adhesive Tape 16.

### Example 1

Three Articles 1 obtained in Preparation Example 1 were provided. Each article was placed such that the glass plate that formed the article was separated by a distance of 10 mm from the light sources of a collimated-light halogen lamp heater (Heattec Co., Ltd., equipped with two 10 cm long halogen lamp tubes, wavelength of light emitted from halogen lamps: 2 μm (near-infrared region), rated voltage: 100 V, rated power consumption: 850 W, portable, weight: 0.7 kg, maximum simultaneous exposure area: about 200 cm²) in an environment at 23° C.

Each Article 1 was then heated using the heater for 5, 10, or 15 seconds. The temperature of the adhesive tape after heating for 5 seconds was about 90° C. The temperature of the adhesive tape after heating for 10 seconds was about 105° C. The temperature of the adhesive tape after beating for 15 seconds was about 120° C.

After heating, each Article 1 was allowed to stand at 23° C. for 5 seconds, and a force was applied to the glass plate that formed Article 1 in the shear direction with a finger in an attempt to separate the glass plate from the article.

### Example 2

Stopping was attempted after heating as in Example 1 except that Articles 1 were replaced with Articles 2 obtained in Preparation Example 2.

### Example 3

Stripping was attempted after heating as in Example 1 except that Articles 1 were replaced with Articles 3 obtained in Preparation Example 3.

### Example 4

Stripping was attempted after heating as in Example 1 except that Articles 1 were replaced with Articles 4 obtained in Preparation Example 4.

### Example 5

Stripping was attempted after heating as in Example 1 except that Articles 1 were replaced with Articles 5 obtained in Preparation Example 5.

### Example 6

Stripping was attempted after heating as in Example 1 except that Articles 1 were replaced with Articles 6 obtained in Preparation Example 6.

### Example 7

Stripping was attempted after heating as in Example 1 except that Articles 1 were replaced with Articles 7 obtained in Preparation Example 7.

### Example 8

Stripping was attempted after heating as in Example 1 except that Articles 1 were replaced with Articles 8 obtained in Preparation Example 8.

### Example 9

Stripping was attempted after heating as in Example 1 except that Articles 1 were replaced with Articles 9 obtained in Preparation Example 9.

### Example 10

Stripping was attempted after healing as in Example 1 except that Articles 1 were replaced with Articles 10 obtained in Preparation Example 10.

### Example 11

Stripping was attempted after heating as in Example 1 except that Articles 1 were replaced with Articles 11 obtained in Preparation Example 11.

### Example 12

Stripping was attempted after heating as in Example 1 except that Articles 1 were replaced with Articles 12 obtained in Preparation Example 12.

### Comparative Example 1

Stripping was attempted after heating as in Example 1 except that Articles 1 were replaced with Articles 13 obtained in Comparative Preparation Example 1.

### Comparative Example 2

Snipping was attempted after heating as in Example 1 except that Articles 1 were replaced with Articles 14 obtained in Comparative Preparation Example 2.

### Comparative Example 3

Stripping was attempted after heating as in Example 1 except that Articles 1 were replaced with Articles 15 obtained in Comparative Preparation Example 3.

### Comparative Example 4

Stripping was attempted after heating as in Example 1 except that Articles 1 were replaced with Articles 16 obtained in Comparative Preparation Example 4.

### Comparative Example 5

Stripping was attempted on Articles 1 after heating as in Example 1 except that the collimated-light halogen lamp heater used in Example 1 (Heattec Co., Ltd., equipped with two 10 cm long halogen lamp tubes, wavelength of light emitted from halogen lamps: 2 μm (near-infrared region) rated voltage: 100 V, rated power consumption: 850 W, portable, weight: 0.7 kg, maximum simultaneous exposure area: about 200 cm²) was replaced with a semiconductor laser (power: 4 W, wavelength: 940 nm, weight: 250 kg, maximum simultaneous exposure area: about 0.1 cm² (local heating)) that was used at a scan speed of 500 mm/min.

### Comparative Example 6

Stripping was attempted on Articles 9 after heating as in Example 9 except that the collimated-light halogen lamp heater used in Example 9 (Heattec Co., Ltd., equipped with two 10 cm long halogen lamp tubes, wavelength of light emitted from halogen lamps: 2 μm (near-infrared region), rated voltage: 100 V, rated power consumption: 850 W, portable, weight: 0.7 kg, maximum simultaneous exposure area: about 200 cm²) was replaced with a semiconductor laser (power: 4 W, wavelength: 940 nm, weight: 250 kg, maximum simultaneous exposure area: about 0.1 cm² (local heating)) that was used at a scan speed of 500 mm/min.

### Comparative Example 7

Stripping was attempted on Articles 1 after heating as in Example 1 except that the collimated-light halogen lamp heater used in Example 1 (Heattec Co., Ltd., equipped with two 10 cm long halogen lamp tubes, wavelength of light emitted from halogen lamps: 2 μm (near-infrared region), rated voltage: 100 V, rated power consumption: 850 W, portable, weight: 0.7 kg, maximum simultaneous exposure area: about 200 cm²) was replaced with a dryer that was set to 120° C.

### Comparative Example 8

Stripping was attempted on Articles 9 after heating as in Example 9 except that the collimated-light halogen lamp heater used in Example 9 (Heattec Co., Ltd., equipped with two 10 cm long halogen lamp tubes, wavelength of light emitted from halogen lamps: 2 μm (near-infrared region), rated voltage: 100 V, rated power consumption: 850 W, portable, weight: 0.7 kg, maximum simultaneous exposure area: about 200 cm²) was replaced with a dryer that was set to 120° C.

### Dynamic Viscoelasticity Measurement of Adhesive Layer

The adhesive components (including the rubber block copolymer or acrylic copolymer and the tackifier resin) used in the manufacture of the adhesive tapes in the Preparation Examples and Comparative Preparation Examples were applied to the surfaces of release liners using an applicator such that the dry thickness was 100 μm and were then dried at 85° C. for 5 minutes to form a plurality of adhesive layers with a thickness of 100 μm for each adhesive.

The adhesive layers formed from each adhesive were then stacked on top of each other to form a test specimen made of an adhesive layer with a thickness of 2 mm.

A viscoelastometer available from TA Instruments Japan (ARES-2kSTD) was equipped with parallel plates with a diameter of 7.9 mm. The test specimen was held between the parallel plates under a compressive load of 40 to 60 g and was tested at a frequency of 1 Hz and a heating rate of 2° C./min over a temperature range of 60 to 150° C. to determine the storage modulus (G₂₃) at 23° C. and the storage modulus (G₁₂₀) at 120° C.

### Ratio of Storage Modulus (G₂₃) at 23° C. to Storage Modulus (G₁₂₀) at 120° C.

The ratio of the storage modulus (G₂₃) 23° C. to the storage modulus (G₁₂₀) at 120° C. determined as described above was calculated.

### Test Method for Adhesion (Surface Adhesion)

The adhesive tapes obtained in the Preparation Examples and Comparative Preparation Examples were each cut into a square frame shape with a length of 14 mm on each side (outer side) and a width of 2 mm in an environmental 23° C.

The cut adhesive tape 2 was attached to a cuboid transparent acrylic plate 1 with a length of 15 mm, a width of 15 mm, and a thickness of 2 mm such that one side of the adhesive tape 2 faced one 15 mm long side of the acrylic plate to obtain Test Specimen 1.

The side of Test Specimen 1 to which the adhesive tape 2 was attached was then attached to a polycarbonate plate 3 with a width of 20 mm, a length of 50 mm, and a thickness of 1 mm that had a hole with a diameter of 10 mm in the center thereof such that the centers thereof were aligned with each other, and was pressed using a press at 80 N/cm² for 10 seconds. After the pressure was released, the adherends were allowed to stand in an environment at 23° C. for 1 hour to obtain Test Specimen 2.

A tensile tester (TENSILON RTA-100 available from A&D Company, Limited, compression mode) equipped with a stainless steel probe 4 with a diameter of 8 mm was then provided. The probe 4 was passed through the hole in the stainless steel plate 3 that formed Test Specimen 2 to apply a force to Test Specimen 1 that formed Test Specimen 2.The strength (N/cm²) required to strip Test Specimen 1 from the polycarbonate plate 3 was measured in temperature environments at 23° C. and 120° C. The speed at which the probe 4 pushed Test Specimen 1 was set to 10 mm/min.

### Test Method for Adhesion (180° Peel Adhesion)

The adhesive tapes obtained in the Examples and Comparative Examples were tested for 180° peel adhesion in accordance with JIS Z 0237. Specifically, the release liner was removed from one side of each adhesive tape, and the adhesive layer was backed with a polyethylene terephthalate film (PET film) with a thickness of 25 μm.

The backed adhesive tape was cut to a width of 20 mm. The release liner was removed from the other side of the adhesive tape, and the adhesive layer was attached to a transparent polycarbonate plate to obtain Test Specimen 3.

Test Specimen 3 was allowed to stand in an environment at 23° C. and 50% RH for 30 minutes. The adhesion required to strip the double-sided adhesive tape that formed Test Specimen 3 from the polycarbonate plate in the 180° direction at a speed of 300 mm/min was measured in temperature environments at 23° C. and 120° C. using a TENSILON tensile tester (A&D Company, Limited, model: RTM-100).

### Test Method for Constant-Load Bearing Capacity

One side of each adhesive tape was backed with a polyethylene terephthalate film with a thickness of 25 μm and was cut to a width of 10 mm and a length of 70 mm to form a test tape. A portion of the test tape with a length of 50 mm was attached to a stainless steel plate, and a 2 kg roller was rolled back and forth once over the test tape to bond them together. The bonded test tape was allowed to stand in an atmosphere at 23° C. and 50% RH for 1 hour and was then placed under a load of 300 g applied in a direction at 90° from the peel direction for 3 hours. The distance by which the test tape peeled from the stainless steel plate was measured and rated on the following criteria. This test method for constant-load bearing capacity is a substitute test method that simulates a situation where an external deforming stress is applied to the test tape for an extended period of time. A longer peel distance indicates a higher constant-load bearing capacity. The measurements shown in the tables are the peel distances (mm) after 3 hours.

### Short-Time Thermal Dismantlability Test

The ease of stripping during the heating and stripping attempted by the methods in the Examples and Comparative Examples was rated on the following criteria.

Excellent: The glass plate that formed the article was separable from the article only by pushing the glass plate with the index finger in the shear direction.

Good: The glass plate that formed the article was separable from the article by pushing the glass plate with the thumb in the shear direction.

Fair: The glass plate that formed the article was separable from the article by holding the glass plate by hand and pulling it with much force in the shear direction.

Poor: The glass plate that formed the article was not separable from the article or movable by holding the glass plate by hand and pulling it with much force in the shear direction.

### Portability of Heater

The heaters used in the Examples and Comparative Examples were rated for portability on the following criteria.

Good: The heater weighed less than 5.0 kg and was possible to carry with one hand.

Poor: The heater weighed not less than 5.0 kg and was impossible to carry with one hand.

TABLE 1

| | | Example 1 | Example 2 | Example 3 | Example 4 | Example 5 | Example 6 |
|---|---|---|---|---|---|---|---|
| Styrene-Butadiene Block Copolymer S | | 100 | 100 | 100 | 100 | | |
| (parts by mass) | | | | | | | |
| Styrene-Butadiene Block Copolymer T | | | | | | 100 | |
| (parts by mass) | | | | | | | |
| Styrene-Butadiene Block Copolymer U | | | | | | | 100 |
| (parts by mass) | | | | | | | |
| Styrene-Butadiene Block Copolymer V | | | | | | | |
| (parts by mass) | | | | | | | |
| Styrene-Butadiene Block Copolymer | | | | | | | |
| W (parts by mass) | | | | | | | |
| Styrene-Butadiene Block Copolymer X | | | | | | | |
| (parts by mass) | | | | | | | |
| Acrylic Copolymer X (parts by mass) | | | | | | | |
| Acrylic Copolymer Y (parts by mass) | | | | | | | |
| C5 petroleum tackifier resin (parts by | | 40 | 40 | 40 | 40 | 40 | 40 |
| mass) | | | | | | | |
| Terpene-phenol tackifier resin (parts by | | | | | | | |
| mass) | | | | | | | |
| Rosin ester resin (parts by mass) | | | | | | | |
| Polymerized rosin ester resin (parts by | | | | | | | |
| mass) | | | | | | | |
| CORONATE L-45 (parts by mass) | | | | | | | |
| Infrared absorber (parts by mass) | | | | | 0.5 | | |
| Thermally expandable microballoons | | | | | | | |
| (parts by mass) | | | | | | | |
| Substrate | | PET film | Substrate | PET film | PET film | PET film | PET film |
| | | | having | having | | | |
| | | | black ink | infrared- | | | |
| | | | layer | absorbing | | | |
| | | | | layer | | | |
| Heater | | Halogen | Halogen | Halogen | Halogen | Halogen | Halogen |
| | | lamp | lamp | lamp | lamp | lamp | lamp |
| Thickness of adhesive layer (one side) | | 100 | 100 | 100 | 100 | 100 | 100 |
| (μm) | | | | | | | |
| Storage modulus | Temperature 23° C. | 5.0E+05 | 5.0E+05 | 5.0E+05 | 5.0E+05 | 5.4E+05 | 4.3E+05 |
| of adhesive layer | Temperature | 5.4E+04 | 5.4E+04 | 5.4E+04 | 5.4E+04 | 5.6E+04 | 3.3E+04 |
| (Pa) | 120° C. | | | | | | |
| Ratio of storage modulus (G₂₃/G₁₂₀) | | 9 | 9 | 9 | 9 | 10 | 13 |
| Surface adhesion | Temperature 23° C. | 70 | 70 | 70 | 70 | 72 | 67 |
| (N/cm²) | Temperature | 5 | 5 | 5 | 5 | 4 | 4 |
| | 120° C. | | | | | | |
| 180° peel | Temperature 23° C. | 30 | 30 | 30 | 30 | 31 | 29 |
| adhesion (N/20 mm) | Temperature | 4 | 4 | 4 | 4 | 4 | 5 |
| | 120° C. | | | | | | |
| Constant-load bearing capacity (mm) | | 5 | 5 | 5 | 6 | 5 | 5 |
| Short-time | Heating time 5 sec. | Good | Good | Good | Good | Good | Good |
| thermal | Heating time 10 sec. | Excellent | Good | Good | Good | Good | Good |
| dismantlability | Heating time 15 sec. | Excellent | Excellent | Good | Excellent | Good | Good |

| | | | | | | |
|---|---|---|---|---|---|---|
| Portability of heater (—) | Good | Good | Good | Good | Good | Good |

TABLE 2

| | | | | | Example | Example | Example |
|---|---|---|---|---|---|---|---|
| | | Example 7 | Example 8 | Example 9 | 10 | 11 | 12 |
| Styrene-Butadiene Block Copolymer S | | | 100 | | | | |
| (parts by mass) | | | | | | | |
| Styrene-Butadiene Block Copolymer T | | | | | | | |
| (parts by mass) | | | | | | | |
| Styrene-Butadiene Block Copolymer U | | | | | | | |
| (parts by mass) | | | | | | | |
| Styrene-Butadiene Block Copolymer V | | 100 | | | | | |
| (parts by mass) | | | | | | | |
| Styrene-Butadiene Block Copolymer W | | | | | | | |
| (parts by mass) | | | | | | | |
| Styrene-Butadiene Block Copolymer X | | | | 100 | 100 | 100 | 100 |
| (parts by mass) | | | | | | | |
| Acrylic Copolymer X (parts by mass) | | | | | | | |
| Acrylic Copolymer Y (parts by mass) | | | | | | | |
| C5 petroleum tackifier resin (parts by | | 40 | 20 | | | | |
| mass) | | | | | | | |
| Terpene-phenol tackifier resin | | | | 65 | 65 | 75 | 65 |
| Rosin ester resin (parts by mass) | | | | | | | |
| Polymerized rosin ester resin (parts by | | | | | | | |
| mass) | | | | | | | |
| CORONATE L-45 (parts by mass) | | | | | | | |
| Infrared absorber (parts by mass) | | | | | | | |
| Thermally expandable microballoons | | | | | | | 15 |
| (parts by mass) | | | | | | | |
| Substrate | | PET | PET | PET film | PET film | PET film | PET film |
| | | film | film | having | containing | having | |
| | | | | black ink | black | black ink | |
| | | | | layer | pigment | layer | |
| Heater | | Halogen | Halogen | Halogen | Halogen | Halogen | Halogen |
| | | lamp | lamp | lamp | lamp | lamp | lamp |
| Thickness of adhesive layer (one side) | | 100 | 100 | 100 | 100 | 100 | 100 |
| (μm) | | | | | | | |
| Storage modulus | Temperature 23° C. | 5.6E+05 | 4.7E+05 | 1.2E+06 | 1.2E+06 | 1.0E+06 | 1.2E+06 |
| of adhesive layer | Temperature 120° C. | 4.7E+04 | 5.0E+04 | 1.5E+05 | 1.5E+05 | 1.0E+05 | 1.5E+05 |
| (Pa) | | | | | | | |
| Ratio of storage modulus (G₂₃/G₁₂₀) | | 12 | 9 | 8 | 8 | 10 | 8 |
| Surface adhesion | Temperature 23° C. | 81 | 73 | 120 | 120 | 125 | 121 |
| (N/cm²) | Temperature 120° C. | 4 | 5 | 11 | 11 | 10 | 0.1 |
| 180° peel | Temperature 23° C. | 30 | 28 | 27 | 27 | 28 | 27 |
| adhesion (N/20 mm) | Temperature 120° C. | 4 | 5 | 7 | 8 | 7 | 8 |
| Constant-load bearing capacity (mm) | | 6 | 5 | 1 | 1 | 1 | 2 |
| Short-time thermal | Heating time 5 sec. | Good | Good | Good | Good | Good | Good |
| dismantlability | Heating time 10 sec. | Good | Good | Good | Good | Good | Good |
| | Heating time 15 sec. | Good | Good | Excellent | Excellent | Excellent | Excellent |

| | | | | | | |
|---|---|---|---|---|---|---|
| Portability of heater (—) | Good | Good | Good | Good | Good | Good |

TABLE 3

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Styrene-Butadiene Block | | | | | | 100 | |
| Copolymer S (parts by | | | | | | | |
| mass) | | | | | | | |
| Styrene-Butadiene Block | | | | | | | |
| Copolymer T (parts by | | | | | | | |
| mass) | | | | | | | |
| Styrene-Butadiene Block | | | | | | | |
| Copolymer U (parts by | | | | | | | |
| mass) | | | | | | | |
| Styrene-Butadiene Block | | | | | | | |
| Copolymer V (parts by | | | | | | | |
| mass) | | | | | | | |
| Styrene-Butadiene Block | | 100 | | | | | |
| Copolymer W (parts by | | | | | | | |
| mass) | | | | | | | |
| Styrene-Butadiene Block | | | | | | | 100 |
| Copolymer X (parts by | | | | | | | |
| mass) | | | | | | | |
| Acrylic Copolymer X | | | 100 | 100 | | | |
| (parts by mass) | | | | | | | |
| Acrylic Copolymer Y | | | | | 100 | | |
| (parts by mass) | | | | | | | |
| C5 petroleum tackifier | | 40 | | | | 40 | |
| resin (parts by mass) | | | | | | | |
| Terpene-phenol tackifier | | | | | | | 65 |
| resin | | | | | | | |
| Rosin ester resin (parts | | | | | 10 | | |
| by mass) | | | | | | | |
| Polymerized rosin ester | | | 30 | 30 | 20 | | |
| resin (parts by mass) | | | | | | | |
| CORONATE L-45 (parts | | | 1.1 | 1.1 | 1.3 | | |
| by mass) | | | | | | | |
| Infrared absorber (parts | | | | | | | |
| by mass) | | | | | | | |
| Thermally expandable | | | | | | | |
| microballoons (parts by | | | | | | | |
| mass) | | | | | | | |
| Substrate | | PET film | PET film | PET film | PET film | PET film | PET film |
| | | | having | | | having black | having black |
| | | | black ink | | | ink layer | ink layer |
| | | | layer | | | | |
| Heater | | Halogen | Halogen | Halogen | Halogen | Semiconductor | Semiconductor |
| | | lamp | lamp | lamp | lamp | laser | laser |
| Thickness of adhesive | | 100 | 100 | 100 | 100 | 100 | 100 |
| layer (one side) (μm) | | | | | | | |
| Storage | Temperature | 3.0E+06 | 8.0E+04 | 8.0E+04 | 1.2E+05 | 5.0E+05 | 1.2E+06 |
| modulus of | 23° C. | | | | | | |
| adhesive | Temperature | 4.2E+05 | 8.3E+03 | 8.3E+03 | 1.1E+04 | 5.4E+04 | 1.5E+05 |
| layer (Pa) | 120° C. | | | | | | |
| Ratio of storage modulus | | 7 | 10 | 10 | 11 | 9 | 8 |
| (G₂₃/G₁₂₀) | | | | | | | |
| Surface | Temperature | 150 | 40 | 39 | 36 | 70 | 120 |
| adhesion | 23° C. | | | | | | |
| (N/cm²) | Temperature | 25 | 8 | 8 | 10 | 5 | 11 |
| | 120° C. | | | | | | |
| 180° peel | Temperature | 45 | 22 | 20 | 21 | 30 | 27 |
| adhesion | 23° C. | | | | | | |
| (N/20 mm) | Temperature | 15 | 14 | 14 | 10 | 4 | 7 |
| | 120° C. | | | | | | |
| Constant-load bearing | | 1 | 15 | 15 | 17 | 5 | 1 |
| capacity (mm) | | | | | | | |
| Short-time | Heating | Poor | Poor | Poor | Poor | Poor | Poor |
| thermal | time 5 sec. | | | | | | |
| dismantlability | Heating | Poor | Fair | Poor | Poor | Poor | Poor |
| | time 10 sec. | | | | | | |
| | Heating | | | | | | |
| | time 15 sec. | Poor | Fair | Fair | Fair | Poor | Poor |

| | | | | | | |
|---|---|---|---|---|---|---|
| Portability of heater (—) | Good | Good | Good | Good | Poor | Poor |

TABLE 4

| | Comparative | Comparative |
|---|---|---|
| | Example 7 | Example 8 |
| Styrene-Butadiene Block Copolymer S | 100 | |
| (parts by mass) | | |
| Styrene-Butadiene Block Copolymer T | | |
| (parts by mass) | | |
| Styrene-Butadiene Block Copolymer U | | |
| (parts by mass) | | |
| Styrene-Butadiene Block Copolymer V | | |
| (parts by mass) | | |
| Styrene-Butadiene Block Copolymer W | | |
| (parts by mass) | | |
| Styrene-Butadiene Block Copolymer X | | 100 |
| (parts by mass) | | |
| Acrylic Copolymer X (parts by mass) | | |
| Acrylic Copolymer Y (parts by mass) | | |
| C5 petroleum tackifier resin (parts by mass) | 40 | |
| Terpene-phenol tackifier resin | | 65 |
| Rosin ester resin (parts by mass) | | |
| Polymerized rosin ester resin (parts by mass) | | |
| CORNONATE L-45 (parts by mass) | | |
| Infrared absorber (parts by mass) | | |
| Thermally expandable microballoons | | |
| (parts by mass) | | |
| Substrate | PET film | PET film |
| | having black | having black |
| | ink layer | ink layer |

### PREPARATION OF MEMBER (MASKING MEMBER)

### Manufacture Example 1

Two rectangular holes with a length of 50 mm and a width of 5 mm were formed at a distance of 30 mm from each other around the center of a polished aluminum plate (infrared emissivity: 4%) with a length of 100 mm, a width of 100 mm, and a thickness of 1 mm to obtain Member (b1) (see FIG. 2).

The infrared emissivity of Member (b1) was measured rising an emissivity meter (TSS-5X, Japan Sensor Corporation, measurement principle: reflected energy detection and calculation with infrared radiation from constant-temperature radiation source) at a specimen/ambient temperature of 23° C., a measurement wavelength of 2 to 22 μm, a measurement area diameter of 15 mm, and a measurement distance of 12 mm (fixed with detection head legs). Specifically, an infrared radiation source (hemispherical blackbody furnace) attached to the emissivity meter was placed on the surface of Member (b1), and the infrared emissivity was measured under the above conditions and was read on a digital indicator.

### Manufacture Example 2

Two rectangular holes with a length of 50 mm and a width of 5 mm were formed at a distance of 30 mm from each other around the center of a copper plate (infrared emissivity: 2%) with a length of 100 mm, a width of 100 mm, and a thickness of 1 mm to obtain Member (b2).

### Manufacture Example 3

Two rectangular holes with a length of 50 mm and a width of 5 mm were formed at a distance of 30 mm from each other around the center of a polished stainless steel (SUS304) plate (infrared emissivity: 25%) with a length of 100 mm, a width of 100 mm, and a thickness of 1 mm to obtain Member (3).

### Manufacture Example 4

Two rectangular holes with a length of 50 mm and a width of 5 mm were formed at a distance of 30 mm from each other around the center of a polished aluminum plate (infrared emissivity: 4%) with a length of 100 mm, a width of 100 mm, and a thickness of 1 mm that had a polyethylene foam layer with a thickness of 200 μm disposed on one side thereof to obtain Member (b4).

### Comparative Manufacture Example 1

Two rectangular holes with a length of 50 mm and a width of 5 mm were formed at a distance of 30 mm from each other around the center of a white polymer alloy resin plate (made of an acrylonitrile-butadiene-styrene resin and a polycarbonate resin, infrared emissivity: 90%) with a length of 100 mm, a width of 100 mm, and a thickness of 1 mm to obtain Member (b5).

### Comparative Manufacture Example 2

Two rectangular holes with a length of 50 mm and a width of 5 mm were formed at a distance of 30 mm from each other around the center of a black acrylonitrile-butadiene-styrene polymer alloy resin plate (infrared emissivity: 98%) with a length of 100 mm, a width of 100 mm, and a thickness of 1 mm to obtain Member (b6).

### METHOD FOR MANUFACTURING ARTICLE

### Example 13

An adhesive tape that was the same as Adhesive Tape 1 used in Preparation Example 1 was cut into strips with a length of 50 mm and a width of 5 mm to obtain two adhesive tape strips.

The two adhesive tape strips were attached along the long sides of a transparent glass plate (Adherend 1) with a length of 50 mm, a width of 40 mm, and a thickness of 0.4 mm to obtain a test specimen.

The side of the test specimen to which the two adhesive tape strips were attached was then attached around the center of a cuboid white polymer alloy resin plate with a length of 100 mm, a width of 100 mm, and a thickness of 1 mm (Adherend 2, made of an acrylonitrile-butadiene-styrene resin and a polycarbonate resin), and was pressed using a press at 80 N/cm² for 10 seconds. After the pressure was released, the adherends were allowed to stand in an environment at 85° C. for 24 hours to obtain Article (13), which was composed of the transparent glass plate, the adhesive tape strips, and the polymer alloy resin plate.

Member (b1) obtained in Manufacture Example 1 was then placed on the top surface of the transparent glass plate that formed Article (13). During the placement, the pattern of the holes in Member (b1) was aligned with the pattern of the adhesive tape strips that formed Article (13) so that the adhesive tape strips were exposed to infrared radiation.

A portable halogen heater (100 V power) available from Heattec Co., Ltd. was placed at a distance of 15 mm from the thermally dismantlable adhesive sheet strips that formed Article (13). The adhesive tape strips were exposed to light in the infrared wavelength region through Member (b1) in an environment at 23° C. for 5 seconds.

After the exposure, Article (13) was allowed to stand in an environment at 23° C. for 5 seconds.

The polymer alloy resin plate that formed Article (13) was then fixed on a horizontal table. A force was applied to the transparent glass plate (Adherend 1) that formed Article (13) in the shear direction relative to the horizontal table in an attempt to strip the transparent glass plate.

### Example 14

Dismantling of an article was attempted as in Example 1 except that Member (b1), serving as a masking member, was replaced with Member (b2).

### Example 15

Dismantling of an article was attempted as in Example 1 except that Member (b1), serving as a masking member, was replaced with Member (b3).

### Example 16

Dismantling of Article (16) was attempted as in Example 1. Article (16) was manufactured as in Example 1 except that the transparent glass plate with a length of 50 mm, a width of 40 mm, and a thickness of 0.4 mm, serving as Adherend 1, was replaced with a transparent acrylic plate with a length of 50 mm, a width of 40 mm, and a thickness of 1 mm, and the cuboid white polymer alloy resin plate with a length of 100 mm, a width of 100 mm, and a thickness of 1 mm (made of an acrylonitrile-butadiene-styrene resin and a polycarbonate resin), serving as Adherend 2, was replaced with a cuboid black acrylonitrile-butadiene-styrene resin plate (ABS resin plate) with a length of 100 mm, a width of 100 mm, and a thickness of 1 mm.

### Example 17

Dismantling of an article was attempted as in Example 4 except that Member (b1), serving as a masking member, was replaced with Member (b2).

### Example 18

Dismantling of an article was attempted as in Example 1 except that Adhesive Tape 1 was replaced with an adhesive tape that was the same as Adhesive Tape 5 used in Preparation Example 5.

### Example 19

Dismantling of an article was attempted as in Example 1 except that Member (b1), serving as a masking member, was replaced with Member (b2), and Adhesive Tape 1 was replaced with an adhesive tape that was the same as Adhesive Tape 5 used in Preparation Example 5.

### Example 20

Dismantling of an article was attempted as in Example 1 except that Member (b1), serving as a masking member, was replaced with Member (b4).

### Example 21

Dismantling of an article was attempted as in Example 1 except that Member (b1), serving as a masking member, was replaced with Member (b5).

### Example 22

Dismantling of an article was attempted as in Example 1 except that Member (b1), serving as a masking member, was replaced with Member (b6).

### Surface Adhesion Test before Exposure to Infrared Radiation

The adhesive tapes used in the Examples and Comparative Examples were each cut into a square frame shape with a length of 14 mm on each side (outer side) and a width of 2 mm in an environment at 23° C.

The cut adhesive tape was attached to a cuboid transparent acrylic plate with a length of 15 mm, a width of 15 mm, and a thickness of 2 mm such that one side of the cut adhesive tape faced one 15 mm long side of the transparent acrylic plate to obtain Test Specimen 1.

The side of Test Specimen 1 to which the adhesive tape was attached was then attached to a stainless steel (SUS304) plate with a width of 20 mm, a length of 50 mm, and a thickness of 1 mm that had a hole with a diameter of 10 mm in the center thereof such that the centers thereof were aligned with each other, and was pressed using a press at 80 N/cm² for 10 seconds. After the pressure was released, the adherends were allowed to stand in an environment at 23° C. for 1 hour to obtain Test Specimen 2.

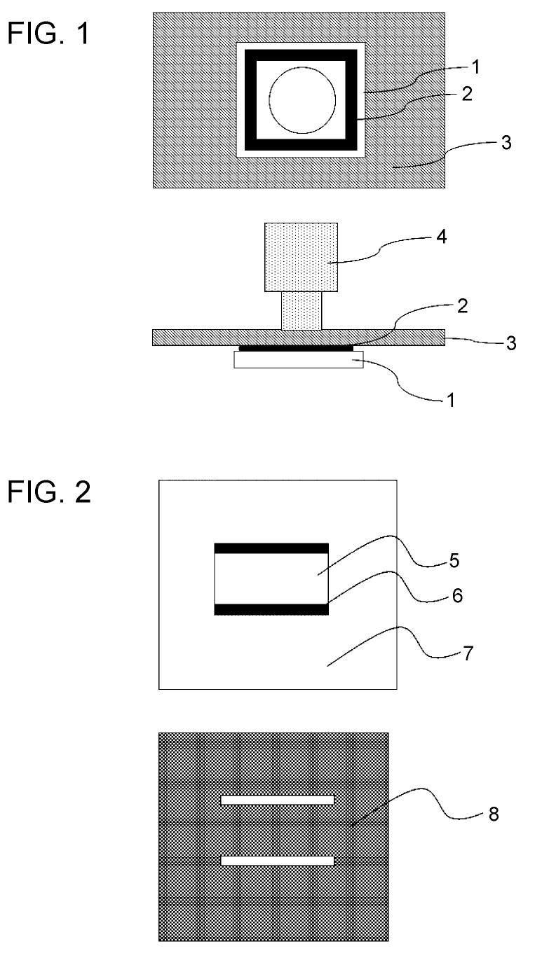

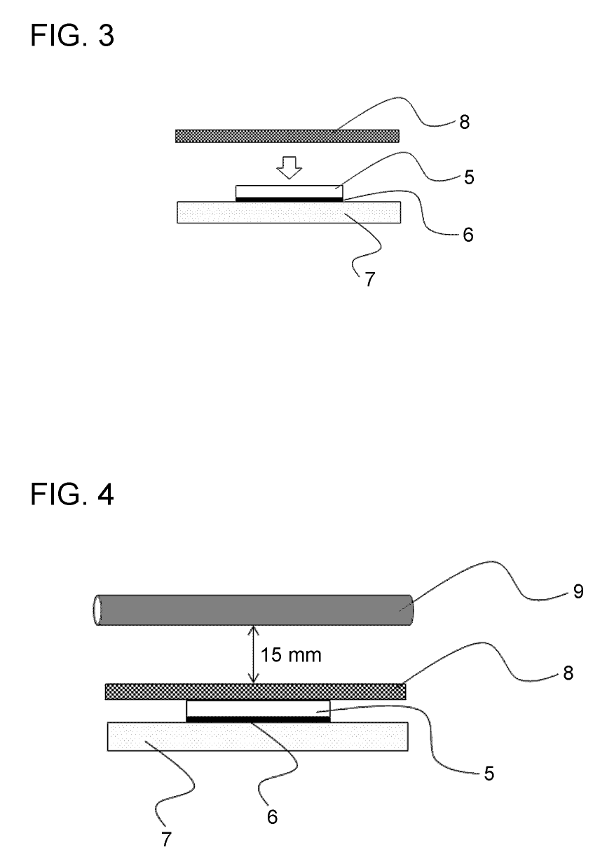

A tensile tester (TENSILON RTA-100 available from A&D Company, Limited, compression mode) equipped with a stainless steel probe with a diameter of 8 mm was then provided. The probe was passed through the hole in the stainless steel (SUS304) plate that formed Test Specimen 2 to apply a force to Test Specimen 1 that formed Test Specimen 2. The strength (N/cm²) required to strip Test Specimen 1 from the polycarbonate plate was measured in temperature environments at 23° C. and 120° C. (see FIG. 1). The speed at which the probe pushed Test Specimen 1 was set to 10 mm/min.

### Dismantlability Test 1 after Exposure to Infrared Radiation

The ease of dismantling during the dismantling of articles attempted by the methods in the Examples and Comparative Examples was rated on the following criteria.

### Test Criteria

Good: The transparent glass plate that formed the article was separable from the polymer alloy resin plate or ABS resin plate by pushing the transparent glass plate that formed the article with the thumb in the shear direction of the article.

Fair: The transparent glass plate that formed the article was separable from the polymer alloy resin plate or ABS resin plate by holding the transparent glass plate that formed the article with one hand and pulling it in the shear direction of the article.

Poor: The transparent glass plate that formed the article was not separable from the polymer alloy resin plate or ABS resin plate or movable relative to the polymer alloy resin plate or ABS resin plate by holding the transparent glass plate that formed the article with one hand and pulling it in the shear direction of the article.

### Dismantlability Test 2 after Exposure to Infrared Radiation

The transparent glass plate and the polymer alloy resin plate or ABS resin plate were visually inspected for surface condition after Dismantlability Test 1 after Exposure to Infrared Radiation and were rated for dismantlability on the following criteria.

### Test Criteria

Good: No damage, deformation, or discoloration was found on either adherend.

Poor: Damage due to melting was found on the surface of either adherend.

TABLE 5

| | | | Example 13 | Example 14 | Example 15 | Example 16 | Example 17 |
|---|---|---|---|---|---|---|---|
| Masking | Type | | Member | Member | Member | Member | Member |
| member | | | (b1) | (b2) | (b3) | (b1) | (b2) |
| | Material | | Polished | Copper | Polished | Polished | Copper |
| | | | aluminum | plate | stainless | aluminum | plate |
| | | | plate | | steel plate | plate | |
| | Infrared emissivity (%) | | 4 | 2 | 25 | 4 | 2 |
| Adherend | Adherend (1) | | Transparent | Transparent | Transparent | Transparent | Transparent |
| | | | glass plate | glass plate | glass plate | acrylic plate | acrylic plate |
| | Adherend (2) | | White | White | White | Black ABS | Black ABS |
| | | | polymer | polymer | polymer | resin plate | resin plate |
| | | | alloy resin | alloy resin | alloy resin | | |
| | | | plate | plate | plate | | |
| Adhesive | Adhesive tape | | (1) | (1) | (1) | (1) | (1) |
| tape | Storage | Test | 5.0E+05 | 5.0E+05 | 5.0E+05 | 5.0E+05 | 5.0E+05 |
| | modulus of | temperature | | | | | |
| | adhesive | 23° C. | | | | | |
| | layer (Pa) | Test | 5.4E+04 | 5.4E+04 | 5.4E+04 | 5.4E+04 | 5.4E+04 |
| | | temperature | | | | | |
| | | 120° C. | | | | | |

| | Ratio of storage modulus | 9 | 9 | 9 | 9 | 9 |
|---|---|---|---|---|---|---|
| | (G₂₃/G₁₂₀) | | | | | |
| Surface adhesion strength (N/cm²) | | 70 | 70 | 70 | 70 | 70 |
| Strippability | Dismantlability 1 (ease | Good | Good | Good | Good | Good |
| upon | of stripping) | | | | | |
| heating | Dismantlability 2 | Good | Good | Good | Good | Good |
| | (intactness of adherend) | | | | | |

TABLE 6

| | | | Example 18 | Example 19 | Example 20 |
|---|---|---|---|---|---|
| Masking | Type | | Member (b1) | Member (b2) | Member (b4) |
| member | Material | | Polished | Copper plate | Polished |
| | | | aluminum plate | | aluminum plate |
| | | | | | with polyethylene |
| | | | | | foam |
| | Infrared emissivity (%) | | 4 | 2 | 4 |
| Adherend | Adherend (1) | | Transparent glass | Transparent glass | Transparent glass |
| | | | plate | plate | plate |
| | Adherend (2) | | White polymer | White polymer | White polymer |
| | | | alloy resin plate | alloy resin plate | alloy resin plate |
| Adhesive | Adhesive tape | | (5) | (5) | (1) |
| tape | Storage modulus | Test | 5.4E+05 | 5.4E+05 | 5.0E+05 |
| | of adhesive layer | temperature | | | |
| | (Pa) | 23° C. | | | |
| | | Test | 5.6E+04 | 5.6E+04 | 5.6E+04 |
| | | temperature | | | |
| | | 120° C. | | | |

| | Ratio of storage modulus | 9 | 9 | 9 |
|---|---|---|---|---|
| | (G₂₃/G₁₂₀) | | | |
| Surface adhesion strength (N/cm²) | | 72 | 72 | 70 |
| Strippability | Dismantlability 1 (ease of | Good | Good | Good |
| upon | stripping) | | | |
| heating | Dismantlability 2 (intactness of | Good | Good | Good |
| | adherend) | | | |

TABLE 7

| | | | Example 21 | Example 22 |
|---|---|---|---|---|
| Masking | Type | | Member (b5) | Member (b6) |
| member | Material | | White polymer alloy | Black polymer alloy |
| | | | resin plate | resin plate |
| | Infrared emissivity (%) | | 90 | 98 |
| Adherend | Adherend (1) | | Transparent glass | Transparent glass |
| | | | plate | plate |
| | Adherend (2) | | White polymer alloy | White polymer alloy |
| | | | resin plate | resin plate |
| Adhesive tape | Adhesive tape | | (1) | (1) |
| | Storage modulus of | Test | 5.0E+05 | 5.0E+05 |
| | adhesive layer (Pa) | temperature | | |
| | | 23° C. | | |
| | | Test | 5.4E+04 | 5.4E+04 |
| | | temperature | | |
| | | 120° C. | | |

| | Ratio of storage modulus (G₂₃/G₁₂₀) | 9 | 9 |
|---|---|---|---|
| Surface adhesion strength (N/cm²) | | 70 | 70 |
| Strippability | Dismantlability 1 (ease of stripping) | Good | Good |
| upon heating | Dismantlability 2 (intactness of | Poor | Poor |
| | adherend) | | |

### REFERENCE SIGNS LIST

1 transparent acrylic plate

2 cut adhesive tape

3 polycarbonate plate or stainless steel (SUS304) plate

4 probe

5 transparent glass plate

6 adhesive tape strip

7 polymer alloy resin plate

8 masking member

9 halogen lamp

1. An adhesive tape comprising an adhesive layer (A) comprising a rubber block copolymer (a), wherein the storage modulus G₁₂₀ of the adhesive component present in the adhesive layer (A) as determined from a dynamic viscoelasticity spectrum at 1 Hz and 120° C. is 1.0×10³ to 2.0×10⁵ Pa, the ratio (G₂₃/G₁₂₀) of the storage modulus G₂₃ of the adhesive component as determined from a dynamic viscoelasticity spectrum at 1 Hz and 23° C. to the storage modulus G₁₂₀ is 1 to 20, and the adhesive tape is used to bond two or more adherends together and is heated using a halogen lamp before or when the two or more adherends bonded together are separated from each other.

2. The adhesive tape according to claim 1, wherein the heating using the halogen lamp comprises heating using a collimated-light halogen lamp heater.

3. The adhesive tape according to claim 1, wherein the adhesive layer (A) is disposed on both sides of a substrate and has a thickness of 25 μm or more.

4. The adhesive tape according to claim 1, wherein the substrate is an infrared-absorbing substrate.

5. A method for dismantling an article comprising two or more adherends bonded together with the adhesive tape according to claim 1, the method comprising heating the adhesive tape by placing the halogen lamp close to or in contact with the adhesive tape or the adherends to allow the two or more adherends to be separated from each other.

6. The method for dismantling the article according to claim 5, wherein the step of heating using the halogen lamp comprises heating the adhesive tape to 100° C. within 20 seconds.

7. The method for dismantling the article according to claim 5, wherein the heating using the halogen lamp comprises heating using a collimated-light halogen lamp heater.

8. An electronic device comprising two or more components bonded together with the adhesive tape according to claim 1.

9. A method for dismantling the electronic device according to claim 8, the method comprising heating the adhesive tape by placing the halogen lamp close to or in contact with the adhesive tape or the components that form the electronic device to allow the two or more components to be separated from each other.

10. A portable electronic terminal comprising a housing and a lens member or another housing that are bonded together with the adhesive tape according to claim 1.

11. A method for dismantling the portable electronic terminal according to claim 10, the method comprising heating the adhesive tape by placing the halogen lamp close to or in contact with the adhesive tape, the housing, or the lens member that forms the portable electronic terminal to allow the housing and the lens member to be separated from each other.

12. A method for dismantling an article comprising at least two adherends (c1) and (c2) bonded together with an adhesive tape, the dismantling method comprising the steps of [1] placing or temporarily fixing a member (b) having an infrared emissivity of 50% or less on a portion of a surface of the article; and [2] exposing a side of the article where the member (b) is placed or temporarily fixed to infrared radiation to allow the adherends (c1) and (c2) to be separated from each other.

13. The dismantling method according to claim 12, wherein step [2] comprises heating the adhesive tape to 70° C. to 150° C. by exposure to infrared radiation.

14. (canceled)

15. The dismantling method according to claim 12, wherein the adhesive tape comprises an adhesive layer (A) comprising a rubber block copolymer (a), wherein the storage modulus G₁₂₀ of the adhesive component present in the adhesive layer (A) as determined from a dynamic viscoelasticity spectrum at 1 Hz and 120° C. is 1.0×10³ to 2.0×10⁵ Pa, the ratio (G₂₃/G₁₂₀) of the storage modulus G₂₃ of the adhesive component as determined from a dynamic viscoelasticity spectrum at 1 Hz and 23° C. to the storage modulus G₁₂₀ is 1 to 20, and the adhesive tape is used to bond two or more adherends together and is heated using a halogen lamp before or when the two or more adherends bonded together are separated from each other.
